(19) United States
(12) Patent Application Publication
(10) Pub. No.: US 2011/0111102 A1
(43) Pub. Date: May 12, 2011

(54) FOOD PRODUCTS AND METHODS OF MAKING FOOD PRODUCTS

(76) Inventor: Michael John Saylock, Kansas City, MO (US)

(21) Appl. No.: 12/736,051

(22) PCT Filed: Feb. 27, 2009
(86) PCT No.: PCT/US09/01309

§ 371 Date: Oct. 27, 2010

Related U.S. Application Data
(60) Provisional application No. 61/067,947, filed on Mar. 3, 2008.

(51) Int. Cl. A23L 1/317

(52) U.S. Cl. 426/240; 426/574; 426/324

(57) ABSTRACT

Methods for producing food products by forming a meat emulsion, processing the meat emulsion to produce one or more meat emulsion chunks, drying the meat emulsion chunks, and combining the dried meat emulsion chunks and one or more hydrating agents to produce a food product having a very realistic meat-like image or appearance similar to that of muscle meat.

### CROSS REFERENCE TO RELATED APPLICATIONS

This application is a national stage application under 35 U.S.C. §371 of PCT/US2009/001309 filed Feb. 27, 2009, which claims priority to U.S. Provisional Application Ser. No. 61/067,947 filed Mar. 3, 2008, the disclosures of which are incorporated herein by this reference.

### BACKGROUND OF THE INVENTION

1. Field of the Invention

The invention relates generally to food products and particularly to food products having a meat-like appearance and texture and to methods of making such food products.

2. Description of Related Art

Animals have been fed “dry” and “wet” food compositions for many years. “Wet” food compositions are generally packaged in can-like containers and are considered “wet” in appearance because of their moisture content, typically greater than about 70% moisture. Several types of wet food products are generally known in the art, i.e., “loaf” and “chunk and gravy.” Generally, chunk and gravy products comprise a preformed meat particle prepared by making a meat emulsion that is extruded and formed by physical pressure or thermal energy such as cooking with steam, cooking in water, oven dry heat, and the like. The product is cut or diced into chunks that are eventually mixed with a gravy or sauce. The two components are then filled into a container that is sealed and sterilized. The chunks are in a gravy-type liquid in the final container. While these meat analog products have many advantages, the products often look like meat pieces that have gravy added to enhance their desirability. It would be more desirable if these products had the appearance of real meat pieces while minimizing the appearance of the gravy. There is, therefore, a need for methods for producing meat analogs that are essentially chunk and gravy products that have a very realistic meat-like image, particularly products that realistically simulate poultry, pork, beef, fish, or other meats.

### SUMMARY OF THE INVENTION

The invention provides food products having a moist meat-like appearance and texture and methods of making such food products, particularly wet food products and wet pet food products. In a general embodiment, the invention provides a method of making a food product comprising forming a meat emulsion, processing the meat emulsion to produce one or more meat emulsion chunks, drying the meat emulsion chunks, and combining the dried meat emulsion chunks and one or more hydrating agents to produce a food product such as a wet food or wet pet food product. The meat emulsion can be made using any suitable meat emulsion process.

In one embodiment, the meat emulsion chunks are dried to a moisture content of from about 25% to about 35% by weight.

In an embodiment, the method comprises placing the dried meat emulsion chunks and at least one hydrating agent into a container and sealing the container. In another, the method comprises sterilizing the dried meat emulsion chunks and the hydrating agent of the sealed container. In a further embodiment, the method comprises hydrating the dried meat emulsion chunks by retorting the sealed container. In a still further embodiment, the method comprises pasteurizing at least one of the dried meat emulsion chunks and the hydrating agent before sealing the container.

In an embodiment, the method comprises adding at least one preservative to the container before sealing the container. The container can be any container suitable for the product, preferably a can, bag, jar, pouch, tray, or combination thereof.

In an embodiment, the container comprises from about 45% to about 70% by weight dried meat emulsion chunks and from about 30% to about 55% by weight hydrating agent.

In an embodiment, the method comprises hydrating the dried meat emulsion chunks to a moisture content ranging from about 55% to about 65% by weight.

In an embodiment, drying the meat emulsion chunks comprises heating the meat emulsion chunks for from about 1 minute to about 10 minutes at from about 140° C. to about 240° C. The chunks can be heated using any suitable method, preferably using a process selected from the group consisting of radiation, convection, and combinations thereof.

In an embodiment, the meat emulsion chunks have a size ranging from about 0.1 to about 4 inches, preferably from about 0.25 to about 3 inches, most preferably from about 0.5 to 1.5 inches.

In an embodiment, the hydrating agent has a moisture content ranging from about 90% to about 100%. The hydrating agent can be any suitable hydrating agent, preferably water, flavored water, a gravy, or a sauce.

In an embodiment, combining the dried meat emulsion chunks and hydrating agent comprises a process selected from the group consisting of (1) adding the hydrating agents into a container and then adding the dried chunks into the container, (2) adding the dried chunks into a container and then adding the hydrating agents into the container, and (3) adding the hydrating agents and the dried chunks into a container at about the same time.

In an embodiment, the method comprises hydrating the dried meat emulsion chunks by heating the sealed container to a temperature of from about 60° C. to about 120° C., preferably from about 40° C. to about 100° C.

In one aspect, the invention provides a method for producing a wet food product, particularly a wet pet food product. The method comprises forming a meat emulsion comprising a protein and a fat, comminuting and heating the meat emulsion, subjecting the meat emulsion to a pressure of at least about 80 psi, venting the meat emulsion and discharging the meat emulsion. The method further comprises processing the meat emulsion to produce meat emulsion chunks, drying the meat emulsion chunks, and combining the dried meat emulsion chunks and at least one hydrating agent to produce the food product.

In an alternative embodiment, the method comprises forming a first meat emulsion comprising a protein, a fat, and a first color, comminuting and heating the meat emulsion to a temperature of about 120° C. to about 165° C., subjecting the meat emulsion to a pressure of at least about 80 psi, passing the meat emulsion through a sintered chamber and discharging the meat emulsion. The method further comprises processing the meat emulsion to produce meat emulsion chunks, drying the meat emulsion chunks, and combining the dried meat emulsion chunks and one or more hydrating agents to produce a food product such as a wet pet food product.

In another embodiment, the method comprises forming a meat emulsion comprising at least one protein and at least one fat, comminuting and heating the meat emulsion to a temperature of at least 132° C., introducing the emulsion into a processing zone and subjecting the meat emulsion to a pressure of at least 100 psi, discharging the meat emulsion from the processing zone, processing the discharged meat emulsion to produce meat emulsion chunks having a size ranging from about 0.1 to about 4 inches, and drying the meat emulsion chunks to a moisture content ranging from about 25% to about 35%. The method further comprises placing the dried meat emulsion chunks and one or more hydrating agents into a container in an amount from about 45% to about 70% by weight dried chunks and from about 55% to about 30% by weight hydrating agent, sealing the container, and hydrating the dried meat emulsion chunks to a moisture content ranging from about 55% to about 65% by weight.

In another aspect, the invention provides a wet pet food product comprising a body defined by a plurality of fibrous structures and a plurality of distinct colors formed from hydrated dried meat emulsion chunks. The wet pet food product has a moisture content ranging from about 55% to about 65% by weight. In one embodiment, the body comprises at least about 29% protein by weight and less than about 9% fat by weight. In various embodiments, the protein is selected from the group consisting of poultry, beef, pork, fish, and combinations thereof. In an embodiment, the plurality of colors gives the outer surface of the meat emulsion an appearance selected from the group consisting of swirling, marbling, shading, and combinations thereof.

In another embodiment, the invention provides a wet pet food product comprising protein, fat, and a plurality of distinct textures formed from hydrated dried meat emulsion chunks. The wet pet food product has a moisture content ranging from about 55% to about 65% by weight. One or more of the textures comprises a plurality of fiber structures integrally formed therewith affording the meat emulsion a realistic meat-like appearance. In an embodiment, the wet pet food product comprises a texturizing ingredient selected from the group consisting of wheat gluten, wheat flour, egg white, sulfur compounds, cysteine, gums, soy proteins, and combinations thereof.

Advantages of the invention include providing improved wet pet food products; improved methods for manufacturing wet pet food products; a wet pet food product that simulates muscle meat; a wet pet food product that has a very realistic, meat-like image; a wet pet food product that has a very realistic meat-like image and retains its integrity and shape when subjected to commercial canning and sterilization procedures such as those required in the production of canned high-moisture food products; a wet pet food that can simulate poultry, pork, beef, or other meat; and enhanced consumer appeal based upon the chunk appearance, i.e., the chunk appears not to have gravy in the product.

Other and further objects, features, and advantages of the invention will be readily apparent to those skilled in the art.

### BRIEF DESCRIPTION OF THE FIGURES

FIG. 1 is photograph of a prior art meat emulsion.

FIG. 2 is a photograph of a meat emulsion in one embodiment of the invention.

FIG. 3 is a schematic of a process for manufacturing a meat emulsion in an embodiment of the invention.

FIG. 4 is a schematic of a process for manufacturing a meat emulsion in a second embodiment of the invention.

FIG. 5 is a schematic of a process for manufacturing a meat emulsion in a third embodiment of the invention.

FIG. 6 is a schematic of a process for manufacturing a meat emulsion in a fourth embodiment of the invention.

FIG. 7 is a schematic of a process for manufacturing a meat emulsion in a fifth embodiment of the invention.

FIG. 8 is a schematic of a process for manufacturing a meat emulsion in a sixth embodiment of the invention.

FIG. 9 is a schematic of a process for manufacturing a meat emulsion in a seventh embodiment of the invention.

FIG. 10 is a schematic of a process for manufacturing wet pet food products in an eighth embodiment of the invention.

FIG. 11 is a photograph of a wet pet food product in one embodiment of the invention.

### DETAILED DESCRIPTION OF THE INVENTION

The invention provides improved food products and methods for manufacturing such products, particularly wet food products and wet pet food products. In various embodiments, the wet pet food products are derived from meat emulsions that have realistic fiber definition. This fiber definition provides a very realistic meat-like image or appearance similar to that of muscle meat. The invention also provides foods for human consumption, particularly wet meat products or emulsions. The food products can simulate any type of meat products including poultry, beef, pork, fish, and combinations thereof.

The wet pet food products can be produced using any suitable meat emulsion technology. Non-limiting examples are described in detail herein. In an embodiment, a method for making the wet pet food products comprises forming a meat emulsion and processing the meat emulsion to produce one or more meat emulsion chunks. The method further comprises drying the meat emulsion chunks and combining the dried meat emulsion chunks and one or more hydrating agents to produce the wet pet food product. The resulting product looks like real meat having a wet or moist appearance.

The terms “fiber-like,” “meat-like” and “kibble-like” when used to describe meat emulsions and meat emulsion products mean that the meat emulsions and products possess, in part, the same or almost the same physical appearance and characteristics as actual fibers, meats, and kibbles, respectively, as understood by the skilled artisan. The meat emulsions and products produced have realistic fiber definition that provides a very realistic meat-like appearance similar to that of muscle meat, i.e., the products are meat analogs.

The term “distinct” when used to describe the colors and/or textures of meat emulsions means that the meat emulsions possess, in part, readily distinguishable or discrete colors and/or textures. The distinct colors and/or distinct textures of the meat emulsion are clear to the senses (e.g. visual, mouthfeel) of an observer or consumer.

Although the claimed wet pet food products are, in part, meat emulsions, they possess the same or almost the same characteristics as that of real meat, particularly in appearance. The resultant products also have a stronger bite/mouth feel and are not pasty, mushy or brittle as compared to other meat emulsions. In addition, moisture reduction may also be accomplished so that the resultant product pieces, although displaying fibers, have a generally kibble-like appearance.

Generally, the wet pet food products can be made from meat emulsions produced by emulsifying meat, protein, water, and various ingredients. The meat emulsion is then run through a high speed emulsion mill wherein the emulsion is rapidly heated to thermally gel it. The heated meat emulsion is then discharged into a heat exchanger in which it solidifies into a striated meat-like structure.

Pursuant to an embodiment of the invention, a food product such as a wet pet food product is produced that has improved fiber definition (visible small diameter fibers) that affords the product a very realistic meat-like image. In this regard, the resultant wet pet food product has fiber bundles or strands that afford the meat emulsion a very realistic muscle meat appearance. It is believed that for a resultant poultry meat emulsion, the product has the appearance of tender slow cooked chicken or turkey that was hand-pulled from the bone covered in its own broth/juice. Additionally, a wet pet food product is produced that has irregular product shape and dimensions, having a stronger bite/mouth feel and is not pasty, mushy or brittle.

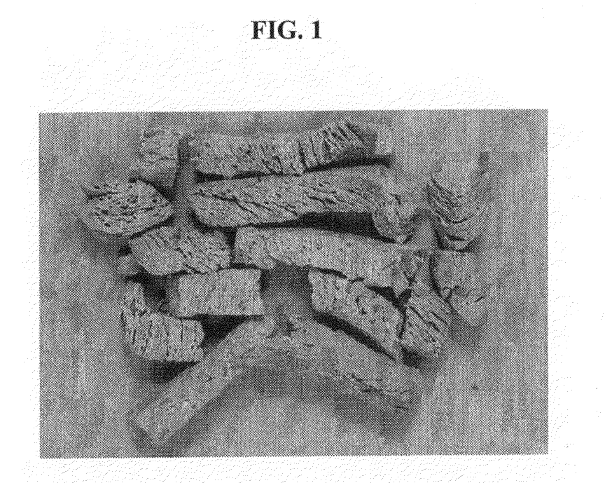

Referring to the Figures, FIG. 1 illustrates a prior art meat emulsion. As set forth in the photograph, the product does not include any fibers, but rather has a homogeneous-like structure.

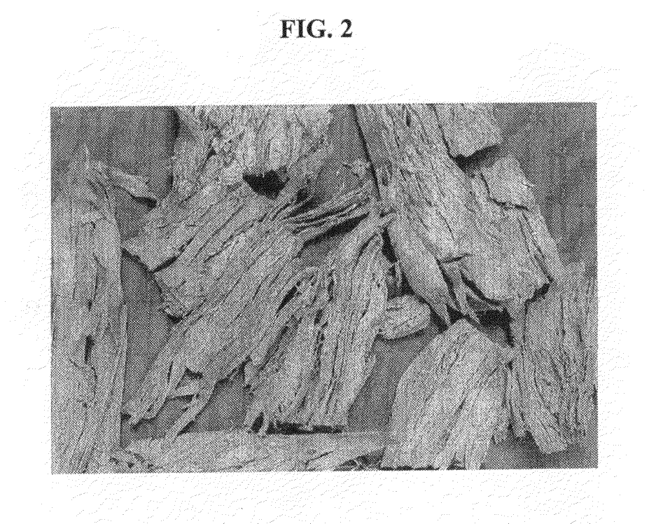

FIG. 2 illustrates a meat emulsion in one embodiment of the invention. As can be seen in the photograph, the product has a plurality of strands of fibers that are linearly arranged in bundles. This provides a more realistic meat-like product than the meat emulsion of FIG. 1.

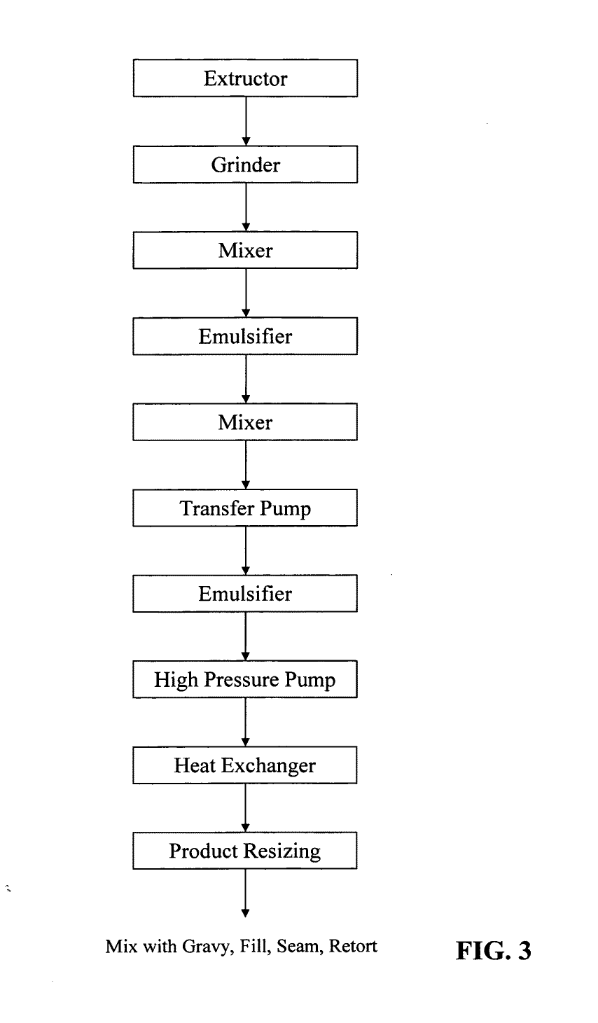

FIG. 3 illustrates a schematic of the general process for a meat emulsion in an embodiment of the invention. In preparing the meat emulsion, a mixture of natural meat materials, including meat from mammals, fish, or fowl and/or meat by-products, having the requisite quality, ingredient cost and palatability, is formulated, ground, and emulsified. For example, the meat material can be emulsified using a high speed blender that reduces the size of the meat materials (along with any added ingredients) via mixing and shearing forces as detailed below.

The meat and/or meat by-products used may be selected from a wide range of components, with the type and amount of meat material used in the formulation depending on a number of considerations such as the intended use of the product, the desired flavor of the product, palatability, cost, availability of ingredients, and the like. Both meat (i.e. skeletal tissue and non-skeletal muscle) from a variety of mammals, fowl, and fish, and/or meat by-products (i.e. the non-rendered clean parts, other than meat, derived from slaughtered mammals, fowl, or fish) may be used as the meat material. Thus, the term meat material as used herein is understood to refer to non-dehydrated meat and/or meat by-products, including frozen materials.

If the product is intended for human consumption, any of the meats and meat by-products used in the production of conventional meat emulsions may be used in the invention, including meats such as whole-carcass beef and mutton, lean pork trim, beef shanks, veal, beef and pork cheek meat, and meat by-products such as lips, tripe, hearts, and tongues. If the product is intended for use as a pet food product, the meat mix may contain, in addition to the meat materials described above, any of the meat by-products that are approved for use in animal foods, such as mechanically deboned beef, chicken, or fish, beef and pork liver, lungs, kidney, and the like. In an embodiment, the meat material can comprise a combination of 3 to 5 different types of meats/byproducts and be formulated to contain a maximum of about 25%, and preferably below about 13%, by weight of fat.

Additives that are used in conventional meat emulsions may be mixed with the meat material prior to or after emulsification and included in the meat emulsion of the invention. These additives include salt, spices, seasoning, sugar, and the like in amounts sufficient to provide the product with desired taste characteristics. In addition, minor amounts of other dry ingredients such as, for example, vitamins, minerals, flavors, and the like, may also be added to the meat emulsion.

One or more dry proteinaceous materials can be added to the meat emulsion. In an embodiment, the dry proteinaceous materials can be added to the meat material after the meat material has been emulsified in a first step. The emulsified meat materials comprising the added dry proteinaceous materials can subsequently be further mixed and subjected to another emulsification step involving high speed blending and shearing forces. It should be appreciated that the dry proteinaceous materials can also be added to the meat materials prior to the first emulsification.

The dry proteinaceous materials may comprise, for example, wheat gluten, soy flour, soy protein concentrate, soy protein isolate, egg albumin, and nonfat dry milk to improve emulsion stability and binding, impart flavor, and reduce formulation costs. The inclusion of the dry proteinaceous materials in the meat emulsion is particularly advantageous in the production of product intended for use as a pet food. Dry proteinaceous material enables the processor to use meat materials having a protein to fat ratio and myosin to total protein ratio which would otherwise be of marginal acceptability for use in preparing meat emulsions. If a dry proteinaceous material is included in the meat emulsion, the amount used may vary from about 5% to about 35% by weight of the emulsion, depending on such factors as the intended use of the product, the quality of meat material used in the emulsion, ingredient cost considerations, and the like. In a preferred embodiment, the level of dry proteinaceous material is from about 25 to about 35% by weight. Generally, as the fat content and/or moisture content of the meat material used are increased, the level of dry proteinaceous material in the emulsion is increased accordingly.

While the formulation of the meat emulsion may vary widely, the emulsion, including the dry proteinaceous material, should have a protein to fat ratio sufficient to form a firm meat emulsion upon coagulation of the protein with no sign of emulsion instability, and the protein content of the emulsion must be such as will enable the emulsion, upon being heated to a temperature above the boiling point of water, to coagulate and form a firm emulsion product within a short period of time, that is, within about 5 minutes, and, preferably within 3 minutes, after being heated to such a temperature. Thus, the meat materials and the additives, including the dry proteinaceous material (if used) are mixed together in proportions such that the meat material is present in an amount of from about 50% to about 75% by weight, and preferably from about 60% to about 70% by weight of the meat emulsion. In a preferred embodiment, the starting ingredients for the meat emulsion comprise approximately 29 to about 31% by weight protein and approximately 4 to about 9% by weight fat. The resultant meat emulsion should have a substantially similar profile to that of the starting ingredients; however, if gravy or broth is added to the product, this profile could change due to the moisture, protein and/or fat content of the gravy/broth.

In addition, the meat emulsion can be formulated to contain from about 45% to about 80% by weight moisture, with the moisture content preferably being controlled from about 49% to about 56% by weight of the meat emulsion, i.e., the meat materials and additives. The exact concentration of water in the emulsion will, of course, depend on the amount of protein and fat in the emulsion.

The meat mix selected for use is passed through a grinder to reduce the meat material into pieces of substantially uniform size. Generally it is preferred to pass the meat through a grinder equipped with a 1 cm or smaller grinding plate. While satisfactory results may be obtained by grinding the meat to a particle size larger than 1 cm, the use of such larger meat particles is generally not preferred. If the meat materials to be used are in a frozen condition, they must first be prebroken or cut into pieces in order to reduce the size of the pieces going into the grinder. While the size of the pieces will depend on the size of the meat grinder intake, normally the frozen meat material is cut into pieces about 10 cm square.

After grinding, the mix of meat particles is conveyed to a mixing tank in which the meat is mixed until uniform, it preferably is heated to a temperature of from about 1° C. to about 7° C. such as by hot water jacketing, steam injection, and the like to facilitate pumping of the meat mix.

The uniform mix of ground meat particles is then comminuted under conditions which emulsify the meat material and form a meat emulsion in which the protein and water of the meat mixture form a matrix that encapsulates the fat globules (e.g. emulsification step). The meat material may be emulsified by any conventional procedure and equipment commonly used in meat emulsification such as by using a mixer, blender, grinder, silent cutter chopper, emulsion mill, and the like which is capable of breaking up and dispersing the fat as globules in the protein slurry to form an emulsion.

Typically the temperature of the meat emulsion increases during the emulsification process. This heating of the meat emulsion is not objectionable as long as the temperature does not increase to the point that protein denaturation begins to occur at an undesirable rate at this stage of the process. The temperature of the meat mixture during emulsification should be maintained below about 49° C. in order to minimize protein denaturing at this stage of the process. According to a preferred embodiment of the disclosure, the meat material is passed through an emulsion mill to emulsify the meat material with the emulsion being heated to a temperature from about 10° C. to about 49° C., preferably from about 21° C. to about 38° C.

The additives to be incorporated in the meat emulsion, including dry proteinaceous material (if used), may be added to the meat mix prior to emulsification. Alternatively, it is frequently preferable to incorporate the additives, particularly the dry proteinaceous material, in the meat mix after emulsification of the meat. Because the addition of the dry proteinaceous material increases the viscosity of the emulsion, better emulsification is obtained when the meat mix is emulsified before the addition of the dry proteinaceous material, which results in the formation of a viscous meat emulsion.

The meat emulsion is again comminuted to increase the fineness of the emulsion (e.g. second emulsification step) and is rapidly heated to a temperature above the boiling point of water, at which temperature the coagulation of protein in the emulsion proceeds so rapidly that the emulsion is set and a firm emulsion product formed within a very short period of time, e.g., 20 seconds or less.

It has been found that rapidly heating the viscous meat emulsion to a temperature above the boiling point of water, and generally from about 120° C. to about 165° C., and more preferably from about 132° C. to about 154° C., will result in the protein in the emulsion coagulating to set the emulsion and form a firm emulsion product within about 5 minutes and typically from a few seconds to about 3 minutes after heating. At this stage in the process, the emulsion is under a pressure of approximately 40 to about 500 psi and preferably 60 to 350 psi. The high temperature, along with increased pressures will provide fiber definition to the product. It has been surprisingly found that the higher the product temperature and pressure the better the fiber development (linear alignment with smaller long fibers).

Preferably, the emulsion is processed in equipment wherein the emulsion is heated to such elevated temperatures while it is being comminuted such as by mechanical heating and/or steam injection. According to a preferred embodiment, the viscous meat emulsion, which is at a temperature of from about 30° C. to about 40° C., is pumped through an emulsion mill in which the meat emulsion is subjected to shearing to increase the fineness of the emulsion and almost simultaneously heat the emulsion to from about 120° C. to about 165° C., preferably 132° C. to about 154° C., through rapid mechanical heating and/or steam injection. Thus, the emulsion preferably is heated to such elevated temperatures in a period of less than about 60 seconds. When the emulsion has been heated to such an elevated temperature in this manner, further significant shearing and cutting of the emulsion should be avoided. Control of the emulsion temperature within the desired range can be effected by adjusting such factors as the feed rate into the emulsion mill, the rotational speed of the emulsion mill, and the like, and can readily be determined by those skilled in the art.

The hot meat emulsion, which is at a temperature above the boiling point of water and generally in the range of from about 120° C. to about 165° C., preferably about 132° C. to about 154° C., is transferred with a positive displacement pump, e.g., a gear or lobe pump, to a holding tube that defines a confined processing zone (e.g. heat exchanging step). In an embodiment, the product is pumped at high pressures of at least about 80 psi or higher. For example, the product can generally be pumped at pressures of about 80 psi to about 600 psi, preferably about 100 psi to about 500 psi, and most preferably 140 psi to about 350 psi into the processing zone. The product can also be pumped at pressures higher than 600 psi using suitable equipment.

At such high pressures, the process operates basically at the emulsifiers upper pressure design limit (235 psi max). For this reason, preferably a gear pump (pressure limit of 500 to beyond 2500 psi.) is close-coupled directly after the emulsifier. This allows the use of the emulsifier to develop the high temperature without the high pressure. The pressure will be developed after the pump. This thereby reduces the pressures in the emulsifier housing to 60 to 100 psi.

In the embodiment illustrated in FIG. 3, the confined processing zone preferably is in the form of an elongated tube, heat exchanger, or similar device where flashing of the product moisture can be controlled. The emulsion is retained in the confined processing zone at a pressure above the vapor pressure of the emulsion until the protein in the meat emulsion has coagulated sufficiently to set the emulsion and form a firm emulsion product, which retains its shape and structure when discharged from the confined processing zone. At such elevated temperature, protein coagulation proceeds at a very rapid rate.

While the period of time required for the hot emulsion to set sufficiently to form a firm product will depend on a number of factors, such as the temperature to which the emulsion is heated and the amount and type of protein in the emulsion, a residence time of from a few seconds to about 3 minutes, and usually from about 1 to about 1.5 minutes, in the elongated tube is generally sufficient for the protein to sufficiently coagulate and form a firm emulsion product which will retain its shape, integrity, and physical characteristics. The residence time in the elongated tube can be controlled by adjusting the flow rate of the emulsion to the elongated tube and/or by adjusting the length of the elongated tube.

The structure of the elongated tube can help to create the fiber structure of the product. In an embodiment, the elongated tube can have a reduced cross-sectional diameter along its length such that the circumference of the tube is smaller as the product proceeds into the tube. In practice, tubes having a length of from about 2.5 m and about 8.0 m and preferably 3.0 m to 6.0 m and an internal diameter of from about 12 mm and about 75 mm are believed to function satisfactorily to form a firm emulsion product. Because the tube has a cross-sectional diameter that decreases along its length, or a portion thereof, the product, as it enters the tube, is squeezed as it flows through the tube. The flow rate and differing pressures on the product help create the fiber structure. By way of example, a tube material is used having a diameter of approximately 62 mm at the opening where the product enters the tube and narrows through a conical reducer to a 25 mm diameter. Tubes of various cross-sectional shapes may be used, such as circular, square, rectangular, and the like as long as a reduction in the diameter is provided.

Preferably, the tube is cooled. This allows the product to be cooled as it is forced through the tube. Typically the tube can be cooled by an external jacket or other means. A rectangular or similar shaped tube may provide a preferred design so as to afford a structure that can be externally cooled and allows the product contained in the center of the tube to be sufficiently cooled.

The set meat emulsion pieces discharged from the confined processing zone are in the form of long strips of products having a temperature of about 65° C. to 100° C., and a moisture content of about 47% to 65%, with the pieces varying in size. Upon discharge from the processing zone, the pieces are rapidly cooled by evaporating cooling to a temperature in the range of 60° C. to 93° C. If desired, suitable cutting means, such as a rotary cut-off knife, a water jet knife, a knife grid, or the like may be mounted at the discharge end of the elongated tube to cut the product into pieces of a desired size, e.g. from about 150 mm to about 350 mm. If desired, the product may be cut down the center to allow the product to more rapidly cool. The meat emulsion chunks thus formed have excellent integrity and strength and will retain their shape and fiber characteristics when subjected to commercial canning and retorting procedures such as those required in the production of canned foods having a high moisture content.

To enhance the fibrous image of the product, a set of compression rolls which consists of two long lightly-toothed cylinders (rolls) that spin at similar speeds can be used. Product that is discharged from the confined processing zone is dropped into a narrow adjustable opening between the spinning cylinders which open up/partially separate/tear the fibers. It has been found that this incomplete shredding functions to emphasize the linear fibers.

The discharged meat emulsion pieces can be subjected to a number of post-discharge steps. For example, the meat emulsion pieces discharged from the confined processing zone may be conveyed to a dryer to remove a large portion of the moisture therefrom, and the dried product collected and stored. Moisture reduction may also be accomplished by exposing the pieces to dry heat, so that the resultant product pieces, although displaying fibers, have a generally kibble-like appearance. The dry heat may be provided by roasting, baking, grilling or frying the body. Preferably, the body is flash-fried. The duration would typically be less than one minute and preferably in the range from 15 to 35 seconds when the oil is in the temperature range from 150° C. to 200° C.

Alternatively, the meat emulsion pieces may be conveyed from the elongated tube directly to a canning operation in which chunks are filled into cans together with other ingredients (such as sauce, gravy, and the like) and the cans retorted. In either situation, the product can be resized if desired.

By way of example, in the production of a canned pet food product, a suitable gravy may be prepared by heating a mixture of water, starch, and condiments. The meat emulsion chunks and gravy are filled into cans in the desired proportions; the cans are vacuum sealed and are then retorted under time-temperature conditions sufficient to effect commercial sterilization. Convention retorting procedures may be used. Typically, a retorting temperature of about 118° C. to 121° C. for approximately 40 to 90 minutes is satisfactory in producing a commercially sterile product.

Several methods are know for producing basic meat emulsion and meat emulsion pieces that can be used in the present invention, e.g., the methods disclosed in U.S. Pat. No. 6,379,738,U.S. Pat. No. 6,649,206; EU Patent No. EP1231846B1; and U.S. patent application Ser. No. 11/612,989. Similar processes using any suitable heat exchanger can be used to form meat emulsions that can be used in the present invention.

In alternative embodiments, the invention provides meat emulsions comprising a plurality of different colors and/or textures. For example, the meat emulsion can comprise a body defined by a plurality of fibrous structures and a plurality of colors. The body can comprise at least about 29% protein by weight and less than about 9% fat by weight. The plurality of colors gives the outer surface of the meat emulsion an appearance such as, for example, swirling, marbling, shading or combinations thereof of different colors. The colors can be derived from any suitable coloring agents such as, for example, caramel, FD&C (Food, Drugs & Cosmetics) certified colors, titanium dioxide, iron oxides, annatto, turmeric, natural colors, artificial colors or combinations thereof.

In another embodiment, the invention provides a meat emulsion comprising protein, fat, and a plurality of distinct textures. For example, one or more of the textures comprises a plurality of fiber structures integrally formed therewith affording the meat emulsion a realistic meat-like appearance. To provide the plurality of distinct textures, the meat emulsion comprises one or more suitable texturizing ingredients. The texturing ingredients can be, for example, wheat gluten, wheat flour, egg white, sulfur compounds, cysteine, gums (e.g. xanthan, algin), soy proteins (e.g. soy protein concentrates and fractions), and combinations thereof.

In an alternative embodiment, the invention provides a meat emulsion comprising a body defined by a plurality of linear strands of fibrous material and a plurality of axial strands of fibrous material that afford the meat emulsion a realistic meat-like appearance.

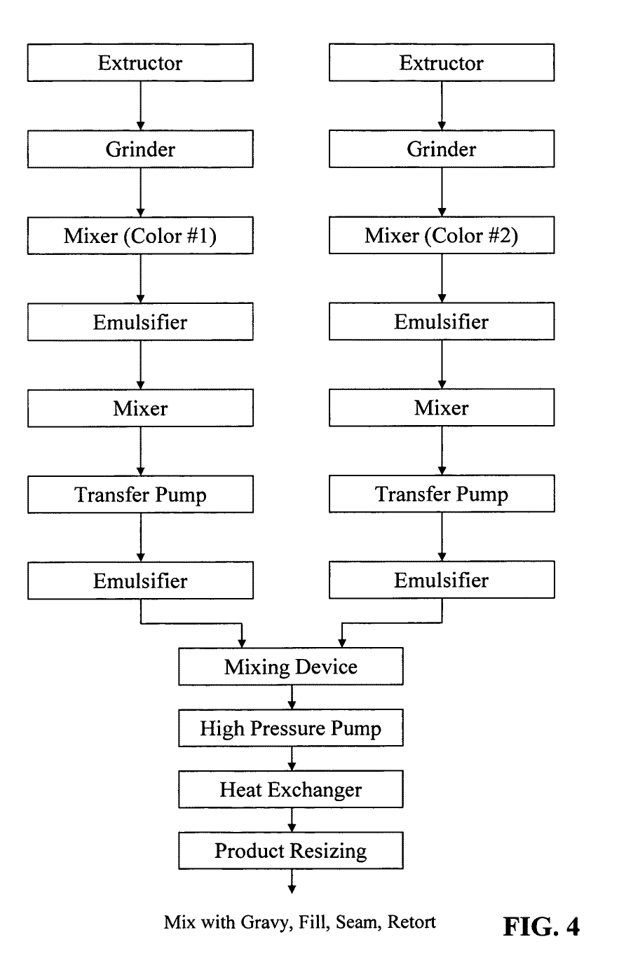

In embodiments illustrated in FIGS. 4 to 9, the invention provides alternative methods for producing meat emulsions having a plurality of distinct colors and/or textures. In an embodiment illustrated in FIG. 4, the invention provides modifying the method discussed previously (and illustrated in FIG. 3) to make a meat emulsion comprising a plurality of colors. For example, the method comprises forming a first meat emulsion comprising a protein, a fat, and a first color and forming a second meat emulsion comprising a protein, a fat and a second color. After the emulsification steps are complete for each product stream, the first meat emulsion is mixed with the second meat emulsion. The mixture can be sufficiently blended at a rate and duration (e.g. using a static mixer) so that the first meat emulsion and second meat emulsion form a single emulsion yet at least two or more colors are apparent from the surface of the mixture.

The mixed meat emulsion is heated (e.g. to a temperature of about 100° C. to about 165° C.) and then subjected to a pressure of about 80 psi to about 600 psi, preferably about 100 psi to about 500 psi, and most preferably 140 psi to about 350 psi in the processing zone. In a subsequent heat exchanging step, the temperature of the mixed meat emulsion coming from the high pressure pump is substantially reduced (e.g. a decrease of about 20° C. to about 40° C.) in a short amount of time in a heat exchanging device or chamber.

The temperature of the meat emulsion prior to or during the high pressurization can range from about 100° C. to about 165° C. and preferably from about 120° C. to about 140° C. The initial temperature right before the heat exchanging step can be controlled depending on the shape and degree of structural fibers that are desired in the final product. The temperature of the mixed meat emulsion can be lowered from about 120° C. to about 165° C. coming from the high pressure pump to about 80° C. to about 125° C. in a period of a few seconds to 10 minutes (preferably from about 1 to about 3 minutes) depending on the degree of structural fiber formation that is desired. The pressurized meat emulsion is discharged to form the meat emulsion and can be subjected to various post-discharge steps as discussed above.

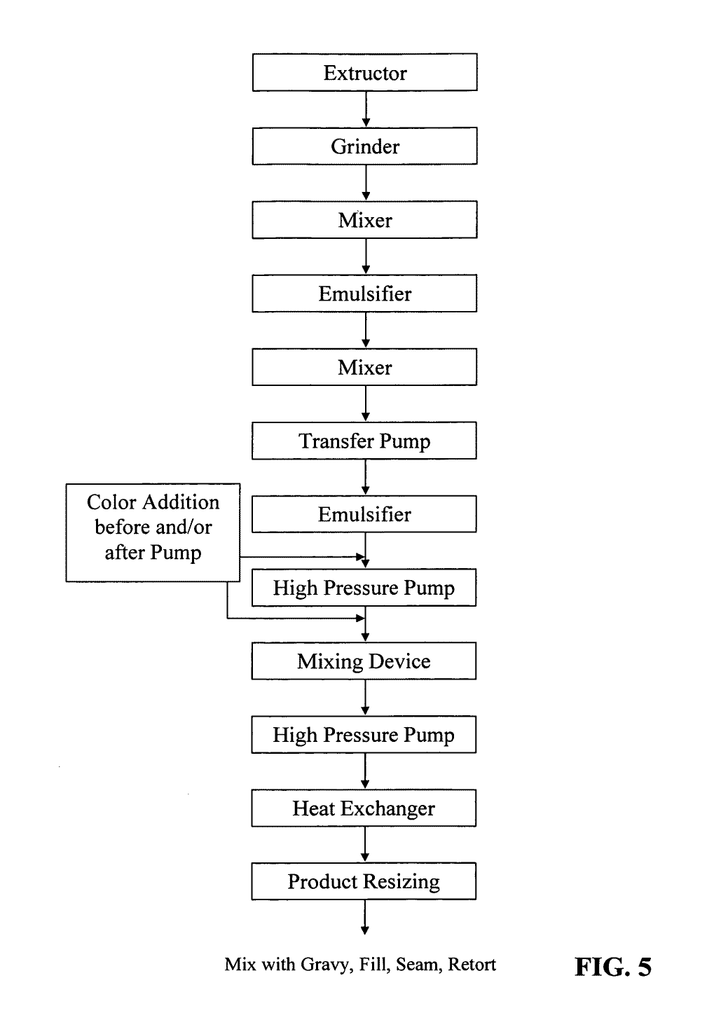

In an alternative embodiment illustrated in FIG. 5, the invention provides a method comprising forming a meat emulsion comprising a protein, a fat, and a first color. The meat emulsion is comminuted and heated, for example, to a temperature of about 100° C. to about 165° C. One or more colors are added to the meat emulsion and mixed with the meat emulsion. For example, the color(s) can be added before and/or after the first high pressure pump step.

The meat emulsion containing the added color(s) can be sufficiently blended at a rate and duration (e.g. using a static mixer) so that at least two or more colors are apparent from the surface of the meat emulsion. The meat emulsion is heated and subjected to a pressure of at least about 80 psi. The pressurized meat emulsion is passed through a heat exchanger to lower the temperature of the meat emulsion to form the meat emulsion. The pressurized meat emulsion is discharged to form the meat emulsion and can be subjected to various post-discharge steps.

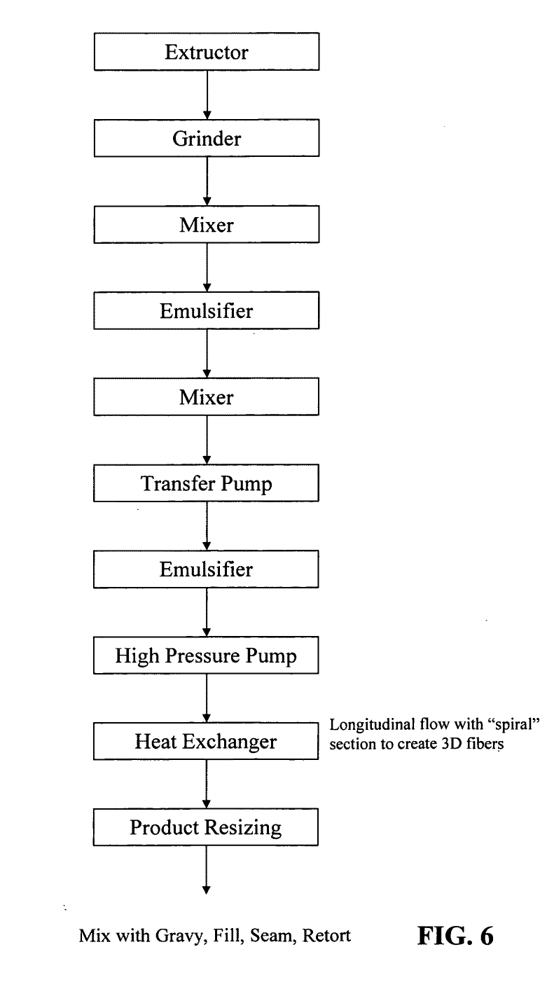

In yet another embodiment illustrated in FIG. 6, the invention provides a method comprising forming a meat emulsion comprising a protein and a fat and comminuting and heating the meat emulsion, for example, to a temperature of about 100° C. to about 165° C. The meat emulsion is heated and subjected to a pressure of at least about 80 psi. The meat emulsion is then subjected to a longitudinal spiraling flow (e.g. before, during or after a heat exchanging process). The spiraling flow can be analogous to a rifling of a gun barrel. The configuration of the meat emulsion flow is such that while moving down the tube in a linear fashion, the meat emulsion also spirals for a period of time such that the 3-D axial fibers form along with the liner fibers to create an appearance similar to a cooked fish texture. The meat emulsion is finally discharged to form the meat emulsion and can be subjected to various post-discharge steps.

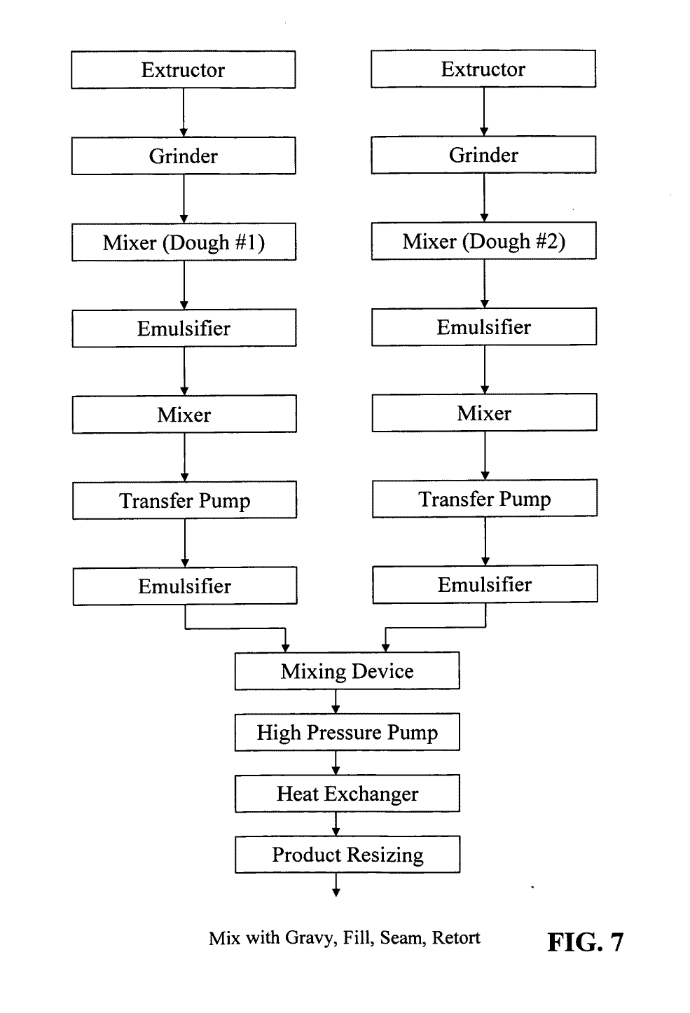

In an alternative embodiment illustrated in FIG. 7, the invention provides a method comprising forming a first meat emulsion comprising a protein, a fat and first texturizing ingredient and forming a second meat emulsion comprising a protein, a fat and a second texturizing ingredient. The first meat emulsion is mixed with the second meat emulsion. The mixed meat emulsion is heated and subjected to a pressure of at least about 80 psi. The pressurized meat emulsion is passed through a heat exchanger to lower the temperature of the meat emulsion to form the meat emulsion having a plurality of textures. The pressurized meat emulsion is discharged to form the meat emulsion and can be subjected to various post-discharge steps.

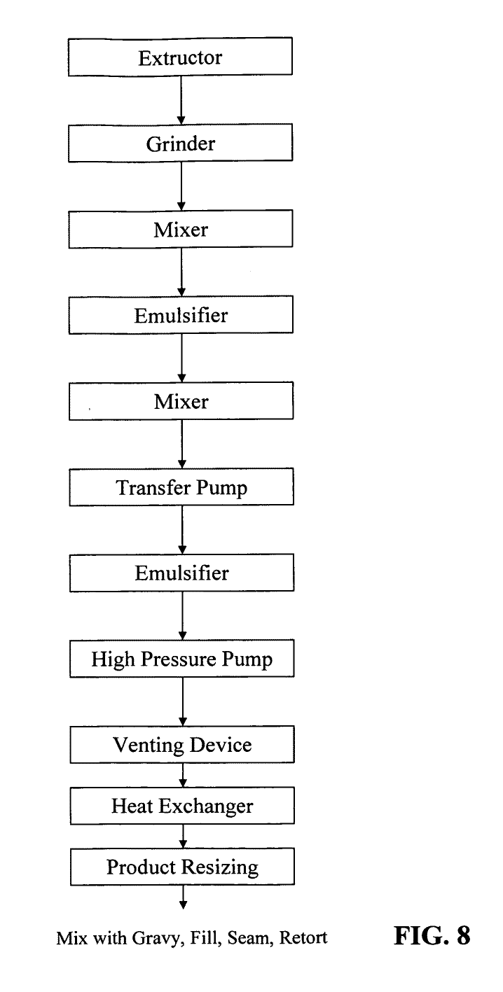

In still another embodiment illustrated in FIG. 8, the invention provides a method comprising forming a meat emulsion comprising a protein and a fat and comminuting and heating the meat emulsion, for example, to a temperature of about 100° C. to about 165° C. The meat emulsion is subjected to a pressure of at least about 80 psi and placed in a heat exchanging device where the meat emulsion is vented/flashed, for example, to release steam/moisture from the meat emulsion. The meat emulsion can be vented for any suitable amount of time to achieve a designed appearance on the meat emulsion. The meat emulsion is discharged to form the meat emulsion and can be subjected to various post-discharge steps.

In the venting/flashing step, the temperature of the mixed meat emulsion coming from the high pressure pump is substantially reduced (e.g. a decrease of about 20° C. to about 40° C.) in a short amount of time by allowing moisture/steam to be released from the meat emulsion in a heat exchanging device or chamber. The extent of temperature change and amount of release of the moisture/steam from the meat emulsion resulting from the change in temperature will affect the amount and degree of fiber definition in the finished product. For example, at a higher initial temperature (e.g. from about 140° C. to about 165° C.), the resulting fibers are more random in shape and appearance. At a lower initial temperature (e.g. from about 100° C. to about 120° C.), the resulting fibers appear denser (e.g. like string cheese).

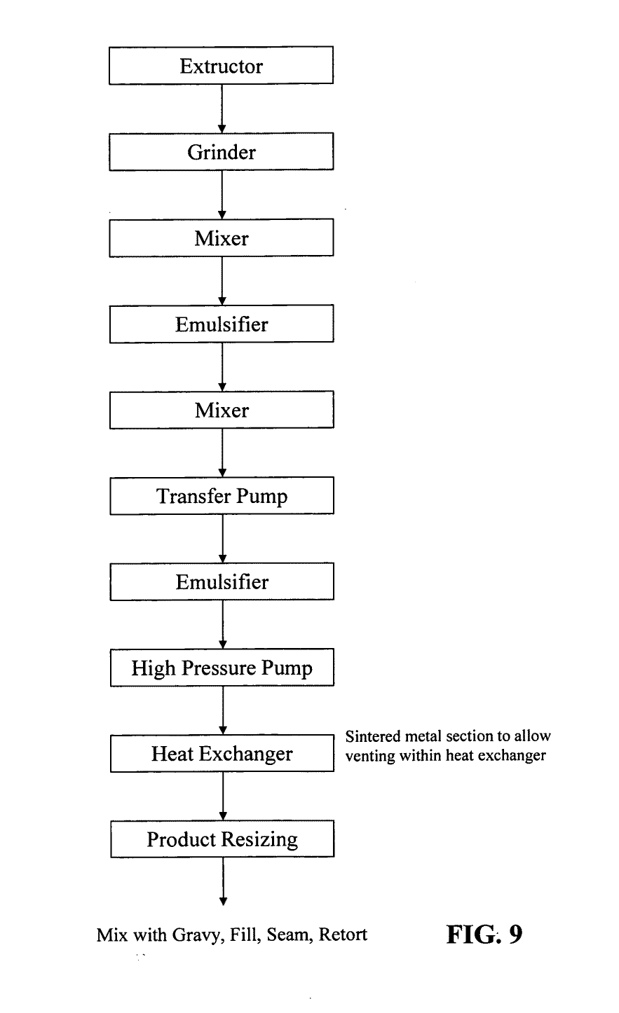

In an alternative embodiment illustrated in FIG. 9, the invention provides method comprising forming a first meat emulsion comprising a protein, a fat, and a first color. The meat emulsion is then comminuted and heated the meat emulsion, for example, to a temperature of about 100° C. to about 165° C. The meat emulsion is subjected to a pressure of at least about 80 psi and passed through a sintered chamber. For example, the sintered chamber can comprise sintered materials (e.g. porous or sponge-like materials) such as metal, ceramic, alloy or other engineered materials that are part of the actual chamber. The sintered chamber can be used as a heat exchanger for controlled release of the steam without flashing as the meat emulsion is subjected to cooling thereby creating a meat emulsion having a unique texture. The pressurized meat emulsion is discharged to form the meat emulsion and can be subjected to various post-discharge steps to form the wet pet food product as described in detail below.

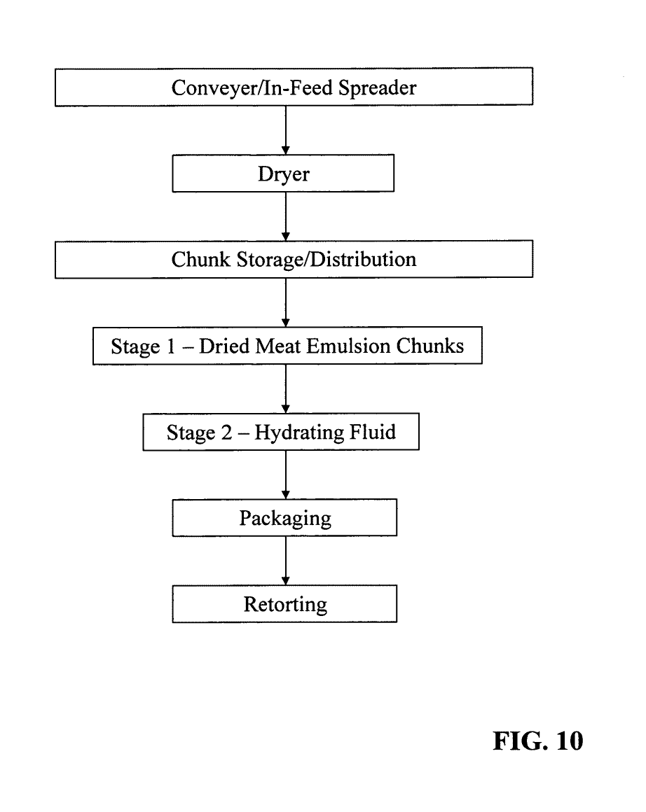

As illustrated in FIG. 10, additional processing steps can be performed to produce the wet pet food product from a meat emulsion. In an embodiment, the method for making the wet pet food product comprises forming the meat emulsion and processing the meat emulsion to produce one or more meat emulsion chunks. The meat emulsion can be made using any suitable meat emulsion process such as, for example, the meat emulsion processes described herein.

The meat emulsion can be processed/cut into one or more meat emulsion chunks using any suitable method, e.g., hand, machine, extruder blade, slicer, etc. The meat emulsion chunks can be cut into any suitable size. These meat emulsion chunks can have any moisture such as, for example, about 55% moisture as a result of the initial meat emulsion process. In an embodiment, the meat emulsion chunks have a size ranging from about 0.1 to about 4 inches. In another embodiment, the meat emulsion chunks have a size ranging from about 0.125 to about 2.5 inches. In yet another embodiment, the meat emulsion chunks have a size ranging from about 0.25 to about 1 inch.

The meat emulsion chunks can then be dried to any suitably reduced moisture content. For example, the meat emulsion chunks can be dried in a TEK Dryer. In an embodiment, drying the meat emulsion chunks comprises heating the meat emulsion chunks from about 1 minute to about 10 minutes at about 140° C. to about 240° C. In another embodiment, drying the meat emulsion chunks comprises heating the meat emulsion chunks from about 3 minute to about 6 minutes at about 150° C. to about 200° C. The meat emulsion chunks can be heated/dried using a process such as radiation, convection or combination thereof. In another embodiment, the meat emulsion can be dried and then cut into a plurality of chunks.

In an embodiment, the meat emulsion chunks are dried to a moisture content ranging from about 25% to about 35% by weight. In another embodiment, the meat emulsion chunks are dried to a moisture content ranging from about 27% to about 33% by weight. In still another embodiment, the meat emulsion chunks are dried to a moisture content ranging from about 28% to about 32% by weight. The chunks can be dried for any suitable amount of time until the meat emulsion chunks have the desired moisture content. This drying produces color and randomized “searing” effects on the chunk's surface.

The method further comprises combining the dried meat emulsion chunks and one or more hydrating agents to produce a wet pet food product. For example, the dried meat emulsion chunks can be placed in a container and a hydrating agent can then be added to the container. Alternatively, the hydrating agent can be added first and the chunks added second or the hydrating agent and the chunks can be added at the same time.

As used herein, the term “hydrating agent” means one or more plasticizing, softening, flavoring and/or nutrient enriched liquids that are capable of diffusing into the dried meat emulsion chunks. For example, the hydrating agent can be in the form of any liquid that can be absorbed by the dried meat emulsion chunks such as water, flavored water, gravies, sauces or any liquid that affects the flavor, texture, aroma and/or nutrition of the dried meat emulsion chunks. The hydrating agent(s) can contain preservatives or other compounds that make the wet pet food product shelf-stable.

Non-limiting examples of hydrating agents are thickeners, Maillard reaction precursors/catalysts, aroma compounds, flavorants, colors and/or preservatives as understood by the skilled artisan. Non-limiting examples of thickeners include gum based thickeners such as guar, xanthan, carrageenan, locust bean gum and cellulose derivatives and starch based thickeners such as corn, wheat, rice, potato, tapioca and arrowroot. Non-limiting examples of Maillard reaction precursors/catalysts include any reducing sugars such as glucose, fructose, lactose, maltose, and xylose. Additional Maillard reaction precursors/catalysts include thiamine or thiamine salts, ascorbic acid, citric acid, malic acid and their sodium salts, amino acids such as glycine, cysteine, methionine, proline, alanine and leucine, and peptides such as animal or vegetable hydrolysates.

Non-limiting examples of aroma compounds and flavorants include smoke compounds/derivatives (e.g. mesquite, hickory, “grilled”, “barbeque”), concentrated meat, seafood or vegetable stocks/bases, herbs, spices. Aroma compounds and flavorants can include essential oils such as basil, sage, rosemary, oregano, dill, lovage, ginger, garlic. Aroma compounds and flavorants can further include hydrolyzed vegetable proteins, nucleotides, guanylate, inositol, monosodium glutamate, enzyme modified animal, vegetable fats/oils, cheese powders and animal digests/hydrolysates

Non-limiting examples of colors include any of the FD&C colorants approved for food usage, any natural-derived color (e.g. mulatto, carmine, beet juice, anthocyanins, turmeric, saffron, paprika, chorella) and inorganics such as iron oxides and titanium dioxide.

Non-limiting examples of preservatives for shelf stability include food-grade acids (e.g. phosphoric, malic, citric, fumaric etc., etc (for pH reduction)), mold inhibitors (e.g. propionic, sorbic acids & their salts) and humectants (e.g. salt, sugar, glycerine, propylene glycol, polyols (sorbitol, xylitol, etc.), hydrogenated starch hydrolysates)

The dried meat emulsion chunks and hydrating agent(s) can be sealed in the container and allowed to sit for any suitable amount of time until hydration occurred. The sealed dried meat emulsion chunks and hydrating agent can also be sterilized/retorted in the container for any suitable amount of time after they are combined. In an embodiment, the method comprises hydrating the dried meat emulsion chunks by heating the sealed container to a temperature ranging from about 60° C. to about 120° C. In another embodiment, the dried meat emulsion chunks can be hydrated by heating the sealed container to a temperature ranging from about 40° C. to about 100° C.

In an embodiment, the dried meat emulsion chunk to hydrating agent weight ratio in the container is from about 45% to about 70% chunk to about 55% to about 30% hydrating agent. In another embodiment, the dried meat emulsion chunk to hydrating agent weight ratio is from about 50% to about 60% chunk to about 50% to about 40% hydrating agent. In an alternative embodiment, the dried meat emulsion chunk to hydrating agent weight ratio is from about 52% to about 55% chunk to about 45% to about 48% hydrating agent.

In an embodiment, the amount of meat emulsion chunks and hydrating agent is such that, when the container is sealed and retorted, the dried meat emulsion chunks hydrate to a moisture content ranging from about 55% to about 65%. The hydrating agent (e.g. gravy) can have a moisture content ranging from about 95% to about 99.9%.

In an alternative embodiment, the dried meat emulsion and hydrating agent(s) can be filled into any suitable retortable container or packaging. The container or packaging can be rigid or flexible. The rigid containers can be, for example, metal cans, glass jars, etc. The flexible containers or packaging can be, for example, pouches, trays, etc. The combination of dried meat emulsion chunks and hydrating fluid can also be enriched with aroma compounds.

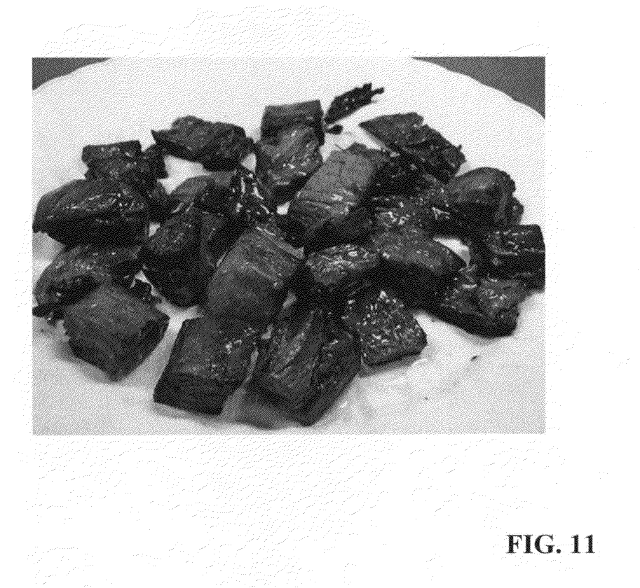

The dried meat emulsion chunks/fluid weight ratios can allow the dried meat emulsion chunks to reach sorption equilibrium (˜60% moisture), for example, through the sterilization process without exhibiting any free-liquid in the finished product. After the hydrating agent is added to the dried meat emulsion chunks in the container, the container can be sealed and then sterilized/retorted for any suitable amount of time. The resulting product looks like real meat having a wet or moist appearance as illustrated in FIG. 11.

In an embodiment, the wet pet food product comprises from about 19% to about 28% by weight protein, from about 3% to about 10% by weight fat and from about 55% to about 65% by weight moisture. In another embodiment, the wet pet food product comprises from about 21% to about 25% by weight protein, from about 5% to about 8% by weight fat and from about 58% to about 62% by weight moisture.

The amount of moisture in the wet pet food product can be in-line with the moisture content of cooked lean muscle tissue (i.e. rib eye, chicken breast, etc.). This wet pet food product has a more realistic meat chunk image as a result of color development during convection heating (“searing”) along with the aroma enhancement and juiciness derived through sorption equilibrium obtained with the hydrating fluid. Consumer appeal can be greatly enhanced through the aesthetic anthropomorphic properties of the wet pet food product and/or the fact there is no “gravy” present in finished product.

The container or packaging comprising the dried meat emulsion chunks and the hydrating agent can be retort or sterilized (radiation or other means) using any suitable process known by the skilled artisan. In an embodiment, the dried meat emulsion chunks and the hydrating agent can be (1) allowed to sit until hydration occurs or (2) heated to a temperature lower than sterilization temperature to cause faster hydration. Alternatively, the container can be heated to a temperature lower than sterilization temperature to cause hydration and the product can be sterilized (radiation or other means). In another embodiment, the dried meat emulsion chunks and the hydrating agent can be placed in a container with preservatives that prevent spoilage, sealed and allowed to sit until hydrated or possibly heated somewhat to speed up the hydration process.

In yet another embodiment, the invention provides a wet pet food product comprising a body defined by a plurality of fibrous structures and a plurality of distinct colors formed from hydrated dried meat emulsion chunks. The wet pet food product has a moisture content ranging from about 55% to about 65% by weight. The plurality of colors can give the outer surface of the meat emulsion an appearance selected from the group consisting of swirling, marbling, shading, and combinations thereof. The body can comprises at least about 29% protein by weight and less than about 9% fat by weight. The protein can be poultry, beef, pork, fish or combinations thereof.

In another embodiment, the invention provides a wet pet food product comprising protein, fat, and a plurality of distinct textures formed from hydrated dried meat emulsion chunks. The wet pet food product has a moisture content ranging from about 55% to about 65% by weight. One or more of the textures comprises a plurality of fiber structures integrally formed therewith affording the meat emulsion a realistic meat-like appearance. The wet pet food product can further comprise a texturizing ingredient selected from the group consisting of wheat gluten, wheat flour, egg white, sulfur compounds, cysteine, gums, soy proteins, and combinations thereof.

In another aspect, the invention provides a blended composition comprising one or more food products of the present invention and one or more other edible compositions comprising one or more food ingredients suitable for consumption by an animal. In one embodiment, the blended composition comprises a food product of the present invention and one or more real meats, different meat analogs, kibbles, food pellets, treats, and the like. The meat and meat analogs are generally pieces or chunks that are compatible in size with the food product, typically having a size that is from about 10% to 500%, preferably from about 25% to 200%, the size of the food product chunks. Generally, the blended composition comprises any ratio or amount of the ingredients but preferably contains from about 10% to about 90% of the food product. The blended composition is appealing to consumers, particularly pets, since is offers a variety of ingredients in a single blended composition, especially ingredients of a different texture and/or taste.

### EXAMPLES

The invention can be further illustrated by the following examples, although it will be understood that these examples are included merely for purposes of illustration and are not intended to limit the scope of the invention unless otherwise specifically indicated.

### Example 1

The formulation shown in Table 1 was used to produce hydrated dried beef chunks. 630 kg of frozen mechanically deboned beef, mechanically deboned chicken, and meat by-products were sized reduced with an extructor/grinder with plate openings 6.35 mm diameter and then was fed to a continuous emulsion mill for further particle size reduction as well as mechanical heating to 34 to 36° C. All of the dry ingredients for the beef chunk (Table 1A) except wheat gluten were added to the emulsified meat blend in the mixer with continuous mixing. 67 kg of water was then added and the slurry mixed for 5 minutes until smooth. The wheat gluten (240 kg) was then added to the slurry which was mixed for a further 5 minutes until a uniformly mixed dough was formed. The moisture of the dough was determined with a microwave heating analyzer. It was 53.95% and within target range. The dough was then pumped to a second continuous emulsifier. In addition to being emulsified, the pressure on and the temperature of the mass increased. The temperature fluctuated in a range 151 to 158° C. and the pressure 160 to 170 psi. The pressurized emulsion was then fed into a heat exchanger with jacketed cooling water (35° C. inlet to 50° C. outlet) that flowed in a counter current direction. The firm, set emulsion product exited the heat exchanger through knife grids in strips and was then diced into irregular pieces of longest sides ranging 6 to 25 mm.

The diced beef chunks were then fed to TEK-Dryer where a combination of convection and radiant heating was applied for 6 minutes at 180° C. and the moisture of the chunks dropped to 29.5%. The dried beef chunks were then placed in a holding bin pending blending with the hydrating fluid.

The fluid composition that was used to rehydrate the dried beef chunks was prepared as follows. For a 500 kg batch, 1.5 kg of xanthan gum was added slowly to 485 kg water in a high speed gum dispersing system. High speed blending continued until the gum was uniformly dispersed. The other ingredients, i.e., salt and flavor (Table 1B), were then added and blended again at high speed until a homogenous mixture was obtained. 80 gram serving packages of the rehydated beef chunk was then produced. Each package was prepared by adding 45.6 grams of the dried chunks to a retortable flexible pouch followed by 34.4 grams of the hydrating fluid (Table 1B). The pouch was heat sealed and retorted.

The resulting food product had moist meat-like appearance and texture and a realistic appearance of beef.

TABLE 1
Beef Formulation

| Ingredients | Weight (kg) |
|---|---|
| A. Beef Chunk | |
| Mechanically Deboned Beef | 240 |
| Meat By-Products | 195 |
| Mechanically Deboned Chicken | 195 |
| Salt | 10 |
| Sugar | 15 |
| Vitamins/Minerals | 7.7 |
| Red Iron Oxide | 0.3 |
| Soy Protein Isolate | 30 |
| Wheat Gluten | 240 |
| Water | 67 |
| Batch Total | 1000 |
| B. Hydrating Fluid | |
| Xanthan Gum | 1.5 |
| Flavor Blend | 11 |
| Salt | 2.5 |
| Water | 485 |
| Batch Total | 500 |
| C. Hydrated Dried Beef Composition | |
| Oven Dried Beef Chunk | 45.6 |
| Hydrating Fluid (B) | 34.4 |
| Batch Total | 80 |

### Example 2

The formulation shown in Table 2 was used to produce hydrated dried chicken chunks. The methodology given in Example 1 was used, except that the moisture of the dough prior to the second emulsification was 55.2%. This moisture was higher than for the beef dough but still within an acceptable range. For chicken chunks, the drying time was 6 minutes but at 157° C. to prevent excessive darkening. The dried chunk moisture was 32.5%. Consequently, the dried chunks to hydrating fluid ratio was increased to 59:41 and hence to make an 80 gram package, 47.2 grams of the dried chicken chunk was combined with 32.8 grams of the hydrating fluid.

The resulting food product had moist meat-like appearance and texture and a realistic appearance of chicken.

Additional chicken products were made having the appearance of chicken dark meat or chicken light meat. The appearance was altered by controlling temperature and/or residence time while drying and the amount of reducing sugar added to the chunk formula. This process permits color development to be “turned up or down” to produce a variety of meat-like products with different appearances.

TABLE 2
Chicken Formulation

| Ingredients | Weight (kg) |
|---|---|
| A. Chicken Chunk | |
| Mechanically Deboned Chicken | 510 |
| Meat By-Products | 110 |
| Salt | 7 |
| Sugar | 5 |
| Vitamins/Minerals | 7.7 |
| Titanium Dioxide | 3.8 |
| Soy Protein Isolate | 30 |
| Wheat Gluten | 240 |
| Water | 86.5 |
| Batch Total | 1000 |
| B. Hydrating Fluid | |
| Xanthan Gum | 1.6 |
| Flavor Blend | 2 |
| Chicken fat (liquid) | 7.5 |
| Salt | 2.5 |
| Water | 486.4 |
| Batch Total | 500 |
| C. Hydrated Dried Chicken Composition | |
| Oven Dried Chicken Chunk | 47.2 |
| Hydrating Fluid (B) | 32.8 |
| Batch Total | 80 |

All patents, patent applications, publications, and other references cited or referred to herein are incorporated herein by reference to the extent allowed by law. The discussion of those references is intended merely to summarize the assertions made therein. No admission is made that any such patents, patent applications, publications or references, or any portion thereof, are relevant prior art for the present invention and the right to challenge the accuracy and pertinence of such patents, patent applications, publications, and other references is specifically reserved.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of making a food product comprising:
forming a meat emulsion;
processing the meat emulsion to produce at least one meat emulsion chunk;
drying the meat emulsion chunks; and
combining the dried meat emulsion chunks and at least one hydrating agent to produce a food product.

2. The method of claim 1 wherein the meat emulsion chunks are dried to a moisture content ranging from about 25% to about 35% by weight.

3. The method of claim 1 comprising placing the dried meat emulsion chunks and at least one hydrating agent into a container and sealing the container.

4. The method of claim 3 comprising sterilizing the dried meat emulsion chunks and the hydrating agent of the sealed container.

5. The method of claim 3 comprising hydrating the dried meat emulsion chunks by retorting the sealed container.

6. (canceled)

7. (canceled)

8. (canceled)

9. The method of claim 3 wherein the container comprises from about 45% to about 70% by weight dried meat emulsion chunks and from about 30% to about 55% by weight hydrating agent.

10. The method of claim 1 wherein the hydrating agent is selected from the group consisting of thickeners, Maillard reaction precursors or catalysts, aroma compounds, flavorants, colors, preservatives, and combinations thereof.

11. The method of claim 1 comprising hydrating the dried meat emulsion chunks to a moisture content ranging from about 55% to about 65% by weight.

12. The method of claim 1 wherein drying the meat emulsion chunks comprises heating the meat emulsion chunks for from about 1 minute to about 10 minutes at from about 140° C. to about 240° C.

13. (canceled)

14. (canceled)

15. The method of claim 1 wherein the hydrating agent has a moisture content ranging from about 90% to about 100% by weight.

16. The method of claim 1 wherein the hydrating agent is in a form selected from the group consisting of water, flavored water, a gravy, a sauce, and combinations thereof.

17. The method of claim 1 wherein combining the dried meat emulsion chunks and hydrating agent comprises a process selected from the group consisting of (1) adding the hydrating agents into a container and then adding the dried chunks into the container; (2) adding the dried chunks into a container and then adding the hydrating agents into the container; and (3) adding the hydrating agents and the dried chunks into a container at about the same time.

18. (canceled)

19. (canceled)

20. (canceled)

21. (canceled)

22. (canceled)

23. A food product comprising a body defined by a plurality of fibrous structures and a plurality of distinct colors formed from hydrated dried meat emulsion chunks having a moisture content ranging from about 55% to about 65% by weight.

24. The food product of claim 23 wherein the plurality of colors gives the outer surface of the meat emulsion an appearance selected from the group consisting of swirling, marbling, shading, and combinations thereof.

25. The food product of claim 23 wherein the body comprises at least about 29% protein by weight and less than about 9% fat by weight.

26. (canceled)

27. The food product of claim 23 further comprising one or more other edible compositions.

28. The product of claim 27 wherein the edible composition is one or more real meats, different meat analogs, or kibbles.

29. (canceled)

30. (canceled)

31. (canceled)

32. (canceled)

33. A product of the method of claim 1.

34. The product of claim 33 further comprising one or more other edible compositions.

35. The product of claim 34 wherein the edible composition is one or more real meats, different meat analogs, or kibbles.

36. (canceled)

37. (canceled)

38. (canceled)

39. (canceled)

40. (canceled)

41. (canceled)

42. (canceled)

43. (canceled)

44. (canceled)
